(19) United States
(12) Patent Application Publication
(10) Pub. No.: US 2010/0020001 A1
(43) Pub. Date: Jan. 28, 2010

(54) ACTIVE MATRIX ARRAY DEVICE

(75) Inventors: Martin Edwards, Sussex (GB); John Richard Alan Ayres, Reigate (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/516,365

(22) PCT Filed: Nov. 26, 2007
(86) PCT No.: PCT/IB2007/054779

§ 371 Date: May 27, 2009

(30) Foreign Application Priority Data
Nov. 28, 2006 (EP) 06124864.7

(51) Int. Cl. G09G 3/36; G09G 3/20

(52) U.S. Cl. 345/92; 345/55

(57) ABSTRACT

An active matrix array device comprises an array of device elements, each device element having an associated circuit. Each circuit comprises an addressing switch (14) and a storage capacitor (20) for maintaining a voltage applied to the device element (16) through the addressing switch (14). Each circuit is associated with a gain element (36), and the storage capacitor (20) is in a feedback path of the gain element. The gain element (36) is used as a way to increase the effective value of the storage capacitor, so as to provide an improvement in the performance of active matrix devices.

### FIELD OF THE INVENTION

The invention relates to an active matrix array device, for example an active matrix display.

### BACKGROUND OF THE INVENTION

Active matrix array devices often use capacitors within the array elements of the device in order to temporarily store information. For example, in the case of a liquid-crystal display (LCD), the voltage required to set the brightness of each display pixel is stored on the capacitance of the pixel. This capacitance typically consists of the capacitance of the liquid crystal cell and an additional storage capacitor. The storage capacitor increases the total capacitance of the pixel and improves the operation of the display, for example by reducing the effect of leakage currents within the transistors of the active matrix array.

The performance of an active matrix display such as an LCD is generally improved by increasing the value of the storage capacitance within each pixel. However, the storage capacitors are normally formed using at least one opaque layer so that increasing the area of the storage capacitor reduces the aperture of the pixel, and therefore the amount of light that can be transmitted through the display.

### SUMMARY OF THE INVENTION

According to the invention, there is provided an active matrix array device comprising an array of device elements, each device element having an associated circuit, each circuit comprising:

an addressing switch; and

a storage capacitor for maintaining a voltage applied to the device element through the addressing switch, wherein a gain element is associated with each circuit, wherein the storage capacitor is in a feedback path of the gain element.

The invention uses a gain element as a way to increase the effective value of the storage capacitor, so as to provide an improvement in the performance of active matrix devices.

The gain element preferably comprises an inverting amplifier. In this case, the storage capacitor can be used as part of a negative feedback loop of an inverting gain element.

In the device element circuit, one side of the storage capacitor may be connected to an input node on which a voltage level, for example the drive voltage of a display element, is stored. The gain element can then apply changes in voltage to the second side of the storage capacitor, which represent an inverted and amplified form of changes in voltage which occur at the first side of the storage capacitor.

The device element is preferably connected between the addressing switch output and a common terminal, and the storage capacitor is connected between the addressing switch output and the output of the gain element. With the input of the gain element connected to the addressing switch output, this defines the storage capacitor in a feedback path.

The gain element may comprise a CMOS inverter, comprising a p-type transistor and an n-type transistor in series between power lines.

In one embodiment, a shorting transistor is provided across the gain element, and the input of the gain element is connected to the addressing switch output via a coupling capacitor. These additional elements make better use of the dynamic range of the gain element, by resetting the gain element during addressing.

In a further embodiment, a shorting transistor is provided across the gain element, and a coupling transistor is connected between the output of the gain element and storage capacitor. This can be used for disabling the gain element.

The device may comprise a display device, for example a liquid crystal display device, wherein each device element comprises a display pixel.

The invention also provides a method of addressing an active matrix array device comprising an array of device elements, the method comprising, for each device element:

applying a drive voltage to the device element; and

storing the drive voltage on a capacitor arrangement, which comprises a storage capacitor in a feedback path of a gain element.

### BRIEF DESCRIPTION OF THE DRAWINGS

Examples of the invention will now be described in detail with reference to the accompanying drawings, in which:

FIG. 1 shows one example of a known pixel configuration for an active matrix liquid crystal display;

FIG. 2 shows a display device including row and column driver circuitry;

FIG. 3 shows a schematic circuit diagram of a pixel circuit of the invention;

FIG. 4 shows an implementation of the circuit of FIG. 3 in more detail;

FIG. 5 shows a second circuit implementation for a pixel circuit of the invention together with a schematic circuit diagram; and

FIG. 6 shows a third circuit implementation for a pixel circuit of the invention together with a schematic circuit diagram.

### DETAILED DESCRIPTION OF THE EMBODIMENTS

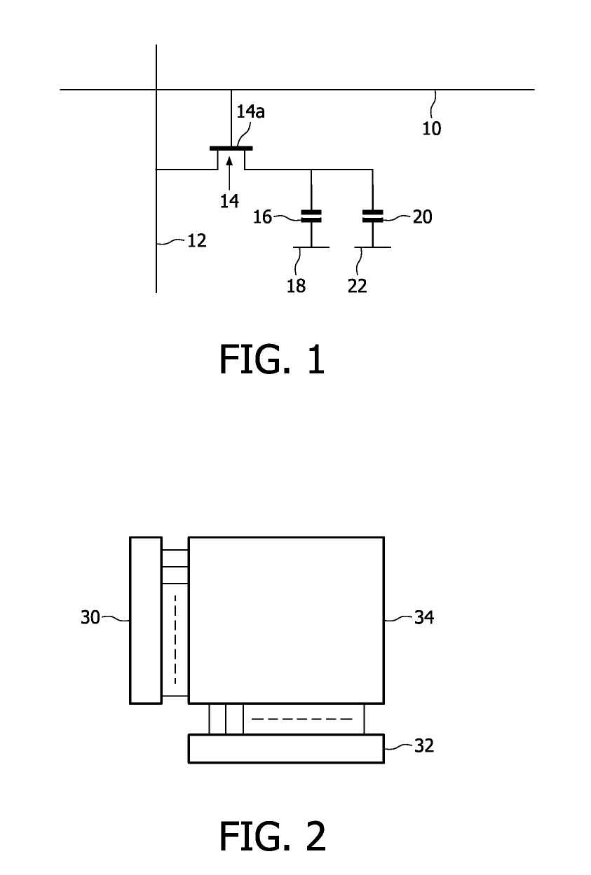

FIG. 1 shows a conventional pixel configuration for an active matrix liquid crystal display. The display is arranged as an array of pixels in rows and columns. Each row of pixels shares a common row conductor 10, and each column of pixels shares a common column conductor 12. Each pixel comprises a thin film transistor 14 and a liquid crystal cell 16 arranged in series between the column conductor 12 and a common electrode 18. The transistor 14 is switched on and off by a signal provided on the row conductor 10. The row conductor 10 is thus connected to the gate 14a of each transistor 14 of the associated row of pixels. Each pixel additionally comprises a storage capacitor 20 which is connected at one end 22 to the next row electrode, to the preceding row electrode, or to a separate capacitor electrode. This capacitor 20 stores a drive voltage so that a signal is maintained across the liquid crystal cell 16 even after the transistor 14 has been turned off.

In order to drive the liquid crystal cell 16 to a desired voltage to obtain a required gray level, an appropriate signal is provided on the column conductor 12 in synchronism with a row address pulse on the row conductor 10. This row address pulse turns on the thin film transistor 14, thereby allowing the column conductor 12 to charge the liquid crystal cell 16 to the desired voltage, and also to charge the storage capacitor 20 to the same voltage. At the end of the row address pulse, the transistor 14 is turned off, and the storage capacitor 20 maintains a voltage across the cell 16 when other rows are being addressed. The storage capacitor 20 reduces the effect of liquid crystal leakage and reduces the percentage variation in the pixel capacitance caused by the voltage dependency of the liquid crystal cell capacitance.

The rows are addressed sequentially so that all rows are addressed in one frame period, and refreshed in subsequent frame periods.

As shown in FIG. 2, the row address signals are provided by row driver circuitry 30, and the pixel drive signals are provided by column address circuitry 32, to the array 34 of display pixels.

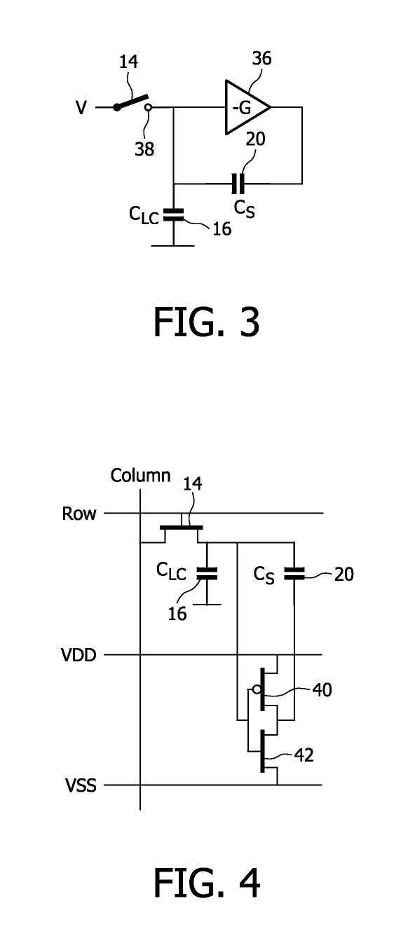

FIG. 3 shows a simplified representation of a pixel circuit for an active matrix liquid crystal display of the invention, and which can be operated using the method of the invention.

The liquid crystal picture element 16 is represented by the capacitor C_{LC}. The addressing transistor 14 is represented by a switch, and the pixel storage capacitor 20 is represented by the capacitor C_{S}. The pixel also incorporates an inverting amplifier 36 having a gain −G. The first terminal of the liquid crystal capacitance 16, a first terminal of the storage capacitor 20 and the input terminal of the amplifier are connected to a common node 38 which represents the pixel electrode. The node 38 is at the output of the addressing switch 14. The output of the inverting amplifier 36 is connected to the second terminal of the storage capacitor 20. In this way, the storage capacitor is in a feedback path between the input and output of the gain element.

When the pixel is addressed, the switch 14 is closed and the liquid crystal capacitance is charged to the drive voltage V. The voltage at the output of the amplifier becomes −GV and the storage capacitor is charged to a voltage (1+G)V. The switch 14 is then opened and the voltage at the pixel electrode is maintained by the capacitors C_{LC} and C_{S}.

Over time, the voltage at the pixel electrode may change due to leakage through the switching device 14 or changes in the liquid crystal capacitance, in the case that the brightness of the pixel has been changed. If the voltage on the pixel electrode changes by an amount ΔV then this change is amplified and inverted by the amplifier so that the voltage at the second terminal of the storage capacitor changes by an amount −G ΔV. The effective value of the storage capacitor is given by the ratio of the charge supplied to the storage capacitor divided by the change in voltage at the pixel electrode:

The change in voltage on the pixel electrode is ΔV and the change on the output of the amplifier is −G ΔV, so that the total change in voltage across the capacitor C_{S} is (1+G) ΔV.

The effective capacitance C_{SE} is given by ΔQ/ΔV, which gives:

C_{SE}=(C_{S}(1+G)ΔV)/ΔV=(I+G)C_{S}

The effective value of the capacitance at the pixel electrode is therefore:

C_{LC}+(1+G)C_{S}

By applying negative feedback to the storage capacitor, the effective value of the storage capacitor can be increased by a factor (1+G).

A diagram indicating in more detail one way in which the circuit of FIG. 3 can be implemented is shown in FIG. 4.

A CMOS inverter formed using a p-type TFT 40 and an n-type TFT 42 provides the inverting gain function. The power supply voltages for the inverter, VDD and VSS, are supplied by additional horizontal electrodes.

A disadvantage of this simple circuit arrangement is that the pixel voltage range over which the storage capacitance value is boosted is limited by the range of input voltage over which the amplifier has a non-zero negative gain. For a high gain amplifier this voltage range is very limited reducing the effectiveness of the storage capacitance boosting.

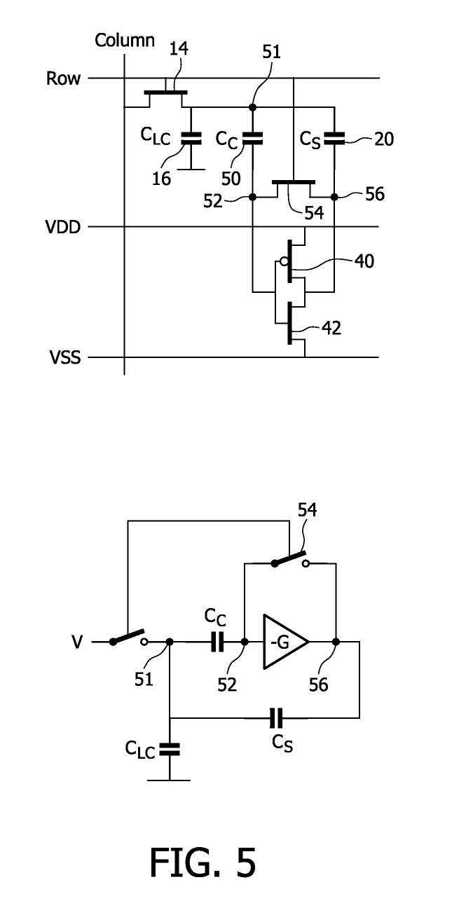

A further modification of the pixel circuit which addresses this limitation is shown in FIG. 5, together with a schematic circuit diagram. A low value capacitor 50 is inserted between the pixel electrode 51 and the input node 52 of the amplifier. A transistor switch 54 is connected between the input node 52 of the amplifier and the output node 56 (i.e. across the amplifier). The gate of this transistor 54 is controlled by the row signal. When the pixel is addressed, the required pixel voltage is applied to the column electrode and the row electrode is taken to a high voltage. This turns on the addressing transistor 14 which is connected between the column electrode and the pixel electrode and also turns on the transistor 54 which is connected across the CMOS inverter.

The capacitor 50 stores the difference between the input threshold voltage of the amplifier and the required pixel voltage. This ensures that the input of the amplifier is biased such that the amplifier operates in its high gain region regardless of the pixel voltage.

This circuit allows the voltage at the pixel electrode to charge to the required level and at the same time the voltage at the input and the output nodes of the amplifier become equal with a value which represents the threshold voltage or input offset voltage of the amplifier. When addressing of the pixel is complete, the row voltage returns to a low level corresponding to the start of the pixel holding period, and the two switching transistors are turned off. The voltage at the input of the amplifier initially remains close to the threshold voltage of the amplifier so that it is biased in the high gain region of operation.

Changes in the pixel voltage which occur after this point in time are coupled to the input of the amplifier by the coupling capacitor 50 which has its first terminal connected to the pixel electrode and its second terminal connected to the input of the amplifier. Corresponding inverted and amplified changes in voltage occur at the output of the amplifier and are applied to the second terminal of the storage capacitor 20. This modified pixel circuit makes better use of the dynamic range of the amplifier circuit and allows the boosting of the storage capacitor value to be implemented over a wide range of pixel voltage levels. In particular, the starting conditions of the gain element are controlled so that the subsequent changes in pixel voltage lie within the normal operating range of the gain element.

FIG. 5 shows the case where the same signal is used to control the two switching transistors. In practice it may be necessary to modify the timing of the signal applied to the switch connected across the amplifier, for example to turn off this transistor while the pixel addressing transistor is still turned on. This would require separate control signals for the two switches.

The amplifier circuit passes a bias current between the two power supply voltage lines VDD and VSS. The current consumed by an individual amplifier is relatively small but if amplifiers are provided within all pixels of the display then the total power consumed will become large. This problem can be avoided by only enabling the amplifier during certain periods of time between successive addressing periods. The amplifier can be disabled by making the voltages on the two power supply lines equal. This would eliminate the bias current of the amplifier however the voltage at the output of the amplifier would become poorly defined.

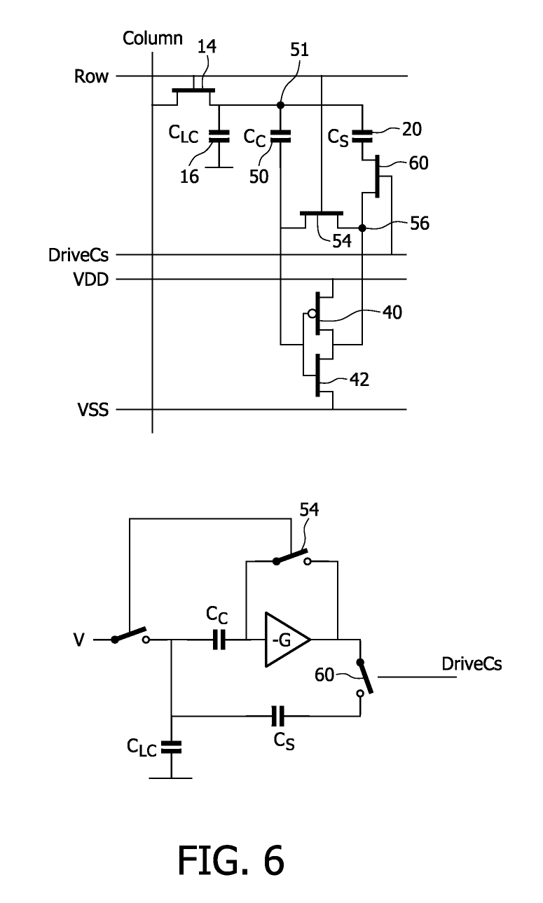

To prevent this from disturbing the voltage on the pixel electrode, an additional transistor switch 60 can be inserted in series with the storage capacitor, for example between the output of the amplifier 56 and the second terminal of the storage capacitor, as shown in FIG. 6. This transistor 60 is controlled by a signal “DriveCs” and is turned off when the amplifier is disabled.

When this transistor is turned off, the voltage at the second terminal of the storage capacitor remains at the voltage present before the amplifier is disabled. When the amplifier is enabled again this transistor can be turned on once more and the output of the amplifier is once again connected to the storage capacitor.

While the amplifier is disabled the pixel behaves as if the storage capacitor were not present and relies on the capacitance of the liquid crystal to maintain the pixel voltage. However, when the amplifier is enabled again the pixel voltage returns to the voltage which would have been present if the amplifier had not been disabled. The amplifier can be enabled a number of times during the holding period of the pixel in order to reduce the magnitude of changes in the pixel voltage due to leakage of charge from the pixel electrode or changes in the liquid crystal capacitance which occur during the holding period.

This description covers some simple implementations of the proposed technique to illustrate how it could be applied to the pixels of an active matrix liquid crystal display. There will be other ways in which the amplifier could be implemented and the power supply and control signals supplied to the pixel circuits.

Furthermore, the invention can be applied to other active matrix array devices, in which a storage capacitor is used to store a device element voltage. The invention may find applications in output devices, such as displays, but also in input devices such as sensors.

One basic implementation of gain element has been shown above, as a two TFT CMOS circuit. This has the advantage of low component count and can easily be fabricated with the same TFT technology as the addressing transistor. However, more complicated gain circuits could be used, and the concept of increasing the effective capacitance in the pixel will still apply.

Since the amplifier circuit consumes area within the pixel it may be preferable to share a single amplifier between a number of pixels. This could either be achieved by time multiplexing the amplifier between the pixels or by connecting the amplifier to all of the pixels simultaneously. In this latter case the second terminals of the Cs and Cc capacitors for all of the pixels would be connected to common nodes and the feedback would reduce the average of the change in voltage on the pixel electrodes.

One possibility is to have one gain element per row of pixels, located at the edge of the display outside the pixel array. With reference to FIG. 5, the common node 56 of the second terminals of the capacitors Cs would then represent the storage capacitor line of the row of pixels, and the common node 52 of the second terminals of the capacitors Cc would represent a coupling capacitor line associated with the row of pixels. The storage capacitor line of the row of pixels (node 56) would then be connected to the output of the gain element at the edge of the array, and the coupling capacitor line (node 52) would be connected to the input of the gain element.

A further possibility is to provide a second pixel storage capacitor in addition to storage capacitor which has its effective value increased by the gain element. This could be of use to enable the amplifier to be disabled to save power. In this case, the first storage capacitor would no longer maintain the pixel voltage because it would then have one terminal which is electrically floating.

The invention can be applied to many different drive schemes, including common electrode driving schemes or capacitively coupled driving schemes. In such drive schemes, the voltage on the second terminals of the storage capacitors is switched between two or more voltage levels.

In order to apply these drive schemes in combination with the method for increasing the effective value of the storage capacitor, it would for example be possible to apply to the second terminals 56 of the storage capacitors, a signal that represents the sum of:

(i) the transitions in voltage which are applied to the second terminals of the storage capacitors in a conventional display with a common electrode or capacitively coupled driving scheme, and
(ii) a signal that represents in inverted and amplified form the difference between the actual pixel voltage and its ideal value.

This requires some increase in the complexity of the amplifier circuit but this may be a suitable approach in the case where the amplifier is located at the edge of the pixel array.

It will be apparent from the description above that each pixel may include a gain element, or multiple pixels may share a gain element, either within the pixel area or outside the pixel area. However, in all cases, each pixel has a capacitor in the feedback path of an associated gain element, even though this gain element may be the same one as associated with other pixels. It will also be apparent from the above that the invention can be applied to different known drive schemes.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An active matrix array device comprising an array of device elements (16), each device element having an associated circuit, each circuit comprising:
an addressing switch (14); and
a storage capacitor (20) for maintaining a voltage applied to the device element through the addressing switch (14), wherein a gain element (36,40,42) is associated with each circuit, wherein the storage capacitor (20) is in a feedback path of the gain element.

2. A device as claimed in claim 1, wherein the gain element (36) comprises an inverting amplifier.

3. A device as claimed in claim 1, wherein the gain element (36) comprises a CMOS inverter, comprising a p-type transistor (40) and an n-type transistor (42) in series between power lines (VDD,VSS).

4. A device as claimed in claim 1, wherein the device element (16) is connected between the addressing switch (14) output and a common terminal, and the storage capacitor (20) is connected between the addressing switch (14) output and the output of the gain element (20).

5. A device as claimed in claim 1, wherein the input of the gain element is connected to the addressing switch output.

6. A device as claimed in claim 1, wherein a shorting switch (54) is provided across the gain element, and the input (52) of the gain element is connected to the addressing switch (14) output via a coupling capacitor (50).

7. A device as claimed in claim 6, wherein a coupling transistor (60) is connected between the output of the gain element and storage capacitor (20).

8. A device as claimed in claim 1, wherein the addressing switch (14) comprises a thin film transistor.

9. A device as claimed in claim 1, comprising a display device, wherein each device element comprises a display pixel.

10. A device as claimed in claim 9, comprising a liquid crystal display device.

11. A method of addressing an active matrix array device comprising an array of device elements (16), the method comprising, for each device element:
applying a drive voltage to the device element (16); and
storing the drive voltage on a capacitor arrangement, which comprises a storage capacitor (20) in a feedback path of a gain element (36).

12. A method as claimed in claim 11, wherein the capacitor arrangement further comprises a capacitance (C_{LC}) of the device element (16).

13. A method as claimed in claim 11, further comprising shorting the input and output of the gain element (36) when applying the drive voltage to the device element (16).

14. A method as claimed in claim 11, for addressing an active matrix liquid crystal display device.
